(19) United States
(12) Patent Application Publication
(10) Pub. No.: US 2026/0312650 A1
(43) Pub. Date: Oct. 8, 2026

(54) ENHANCED CHANNEL STATE INFORMATION DERIVATION

(71) Applicant: Nokia Technologies Oy, Espoo (FI)

(72) Inventors: Matha DEGHEL, Massy (FR); Filippo TOSATO, Massy (FR)

(21) Appl. No.: 19/482,677

(22) PCT Filed: Apr. 17, 2024
(86) PCT No.: PCT/EP2024/060414

§ 371 Date: Nov. 7, 2025

Related U.S. Application Data
(60) Provisional application No. 63/467,374, filed on May 18, 2023.

(51) Int. Cl. H04B 7/06; H04B 17/318; H04W 52/32

(52) U.S. Cl. CPC H04B 7/0626; H04B 17/328; H04W 52/32

(57) ABSTRACT

A UE receives a CSI report configuration comprising multiple sub-configurations, and determines a reference for a power control factor. The UE determines, based at least in part on the reference for the power control factor, the power control factor for a sub-configuration of the multiple sub-configurations. The UE transmits, to the network, a CSI report associated with the sub-configuration, wherein the CSI report comprises one or more CSI quantities. At least one of the one or more CSI quantities is determined based on the power control factor for the sub-configuration. A network element sends a CSI report configuration comprising multiple sub-configurations to a UE and receives a CSI report associated with a sub-configuration of the multiple sub-configurations. The CSI report includes one or more CSI quantities determined based on a power control factor for the sub-configuration. The network element determines a spatial pattern based on the received CSI report.

### CROSS-REFERENCE TO RELATED APPLICATION

This application claims the benefit of U.S. Provisional Application No. 63/467,374, filed May 18, 2023. The entire content of the above-referenced application is hereby incorporated by reference.

### TECHNICAL FIELD

Examples of embodiments herein relate generally to wireless communications and, more specifically, relate to channel state information (CSI) in such communications.

### BACKGROUND

In wireless communications networks, such as cellular networks, there is a lot of information that is exchanged between devices connecting to the network, commonly referred to as User Equipment (UE or UEs for plural), and the network. One such item is Channel State Information (CSI), which provides channel properties of a communication link between the UE and network.

To measure CSI, reference signals (RSs) are often used, and these RSs are sent by the network to the UE. The UE measures these and bases CSI on the measured RSs, and sends a CSI report having indication of the CSI in it to the network.

Because wireless communications have become so complex, a UE can be configured by the network with many different CSI report configurations, having multiple sub-configurations. Furthermore, the UE can derive CSI feedback based on power between different Resource Elements (REs) that are being used, and CSI feedback can be affected by antenna ports that being used in the sub-configurations. Since at least some of this can be modified dynamically, it could be useful to facilitate how CSI feedback is determined in certain situations.

### BRIEF SUMMARY

This section is intended to include examples and is not intended to be limiting.

In an exemplary embodiment, a method is disclosed that includes receiving, at a user equipment from a network, a channel state information report configuration comprising multiple sub-configurations; determining, by the user equipment, a reference for a power control factor; determining, by the user equipment, based at least in part on the reference for the power control factor, the power control factor for a sub-configuration of the multiple sub-configurations; and transmitting, by the user equipment to the network, a channel state information report associated with the sub-configuration, wherein the channel state information report comprises one or more channel state information quantities, and at least one of the one or more channel state information quantities is determined based on the power control factor for the sub-configuration.

An additional exemplary embodiment includes a computer program, comprising instructions for performing the method of the previous paragraph, when the computer program is run on an apparatus. The computer program according to this paragraph, wherein the computer program is a computer program product comprising a computer-readable medium bearing the instructions embodied therein for use with the apparatus. Another example is the computer program according to this paragraph, wherein the program is directly loadable into an internal memory of the apparatus.

An exemplary apparatus includes one or more processors and one or more memories storing instructions that, when executed by the one or more processors, cause the apparatus at least to perform: receiving, at a user equipment from a network, a channel state information report configuration comprising multiple sub-configurations; determining, by the user equipment, a reference for a power control factor; determining, by the user equipment, based at least in part on the reference for the power control factor, the power control factor for a sub-configuration of the multiple sub-configurations; and transmitting, by the user equipment to the network, a channel state information report associated with the sub-configuration, wherein the channel state information report comprises one or more channel state information quantities, and at least one of the one or more channel state information quantities is determined based on the power control factor for the sub-configuration.

An exemplary computer program product includes a computer-readable storage medium bearing instructions that, when executed by an apparatus, cause the apparatus to perform at least the following: receiving, at a user equipment from a network, a channel state information report configuration comprising multiple sub-configurations; determining, by the user equipment, a reference for a power control factor; determining, by the user equipment, based at least in part on the reference for the power control factor, the power control factor for a sub-configuration of the multiple sub-configurations; and transmitting, by the user equipment to the network, a channel state information report associated with the sub-configuration, wherein the channel state information report comprises one or more channel state information quantities, and at least one of the one or more channel state information quantities is determined based on the power control factor for the sub-configuration.

In another exemplary embodiment, an apparatus comprises means for performing: receiving, at a user equipment from a network, a channel state information report configuration comprising multiple sub-configurations; determining, by the user equipment, a reference for a power control factor; determining, by the user equipment, based at least in part on the reference for the power control factor, the power control factor for a sub-configuration of the multiple sub-configurations; and transmitting, by the user equipment to the network, a channel state information report associated with the sub-configuration, wherein the channel state information report comprises one or more channel state information quantities, and at least one of the one or more channel state information quantities is determined based on the power control factor for the sub-configuration.

In an exemplary embodiment, a method is disclosed that includes sending, by a network element to a user equipment, a channel state information report configuration comprising multiple sub-configurations; receiving a channel state information report associated with a sub-configuration of the multiple sub-configurations, wherein the channel state information report comprises one or more channel state information quantities determined based on a power control factor for the sub-configuration; and determining a spatial pattern based on the received channel state information report.

An additional exemplary embodiment includes a computer program, comprising instructions for performing the method of the previous paragraph, when the computer program is run on an apparatus. The computer program according to this paragraph, wherein the computer program is a computer program product comprising a computer-readable medium bearing the instructions embodied therein for use with the apparatus. Another example is the computer program according to this paragraph, wherein the program is directly loadable into an internal memory of the apparatus.

An exemplary apparatus includes one or more processors and one or more memories storing instructions that, when executed by the one or more processors, cause the apparatus at least to perform: sending, by a network element to a user equipment, a channel state information report configuration comprising multiple sub-configurations; receiving a channel state information report associated with a sub-configuration of the multiple sub-configurations, wherein the channel state information report comprises one or more channel state information quantities determined based on a power control factor for the sub-configuration; and determining a spatial pattern based on the received channel state information report.

An exemplary computer program product includes a computer-readable storage medium bearing instructions that, when executed by an apparatus, cause the apparatus to perform at least the following: sending, by a network element to a user equipment, a channel state information report configuration comprising multiple sub-configurations; receiving a channel state information report associated with a sub-configuration of the multiple sub-configurations, wherein the channel state information report comprises one or more channel state information quantities determined based on a power control factor for the sub-configuration; and determining a spatial pattern based on the received channel state information report.

In another exemplary embodiment, an apparatus comprises means for performing: sending, by a network element to a user equipment, a channel state information report configuration comprising multiple sub-configurations; receiving a channel state information report associated with a sub-configuration of the multiple sub-configurations, wherein the channel state information report comprises one or more channel state information quantities determined based on a power control factor for the sub-configuration; and determining a spatial pattern based on the received channel state information report.

### BRIEF DESCRIPTION OF THE DRAWINGS

In the attached drawings:

FIG. 1A is a block diagram of one possible and non-limiting exemplary system in which the exemplary embodiments may be practiced;

FIG. 1B is an example of a block diagram of an apparatus suitable for implementing any of the nodes in FIG. 1A;

FIG. 2, split into FIGS. 2A, 2B, 2C, and 2D, illustrates an example illustrating some spatial (adaptation) patterns, where dotted/grey boxes correspond to muted spatial elements;

FIG. 3, which is split over FIGS. 3A, 3B, and 3C, is a flowchart performed by a UE of facilitating CSI derivation considering spatial adaptation in accordance with an example; and

FIG. 4 is a flowchart performed by a network element of facilitating CSI derivation considering spatial adaptation in accordance with an example.

### DETAILED DESCRIPTION OF THE DRAWINGS

Abbreviations that may be found in the specification and/or the drawing figures are defined below, at the end of the detailed description section.

The word “exemplary” is used herein to mean “serving as an example, instance, or illustration.” Any embodiment described herein as “exemplary” is not necessarily to be construed as preferred or advantageous over other embodiments. All of the embodiments described in this Detailed Description are exemplary embodiments provided to enable persons skilled in the art to make or use the invention and not to limit the scope of the invention which is defined by the claims.

When more than one drawing reference numeral, word, or acronym is used within this description with “/”, and in general as used within this description, the “/” may be interpreted as “or”, “and”, or “both”.

As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

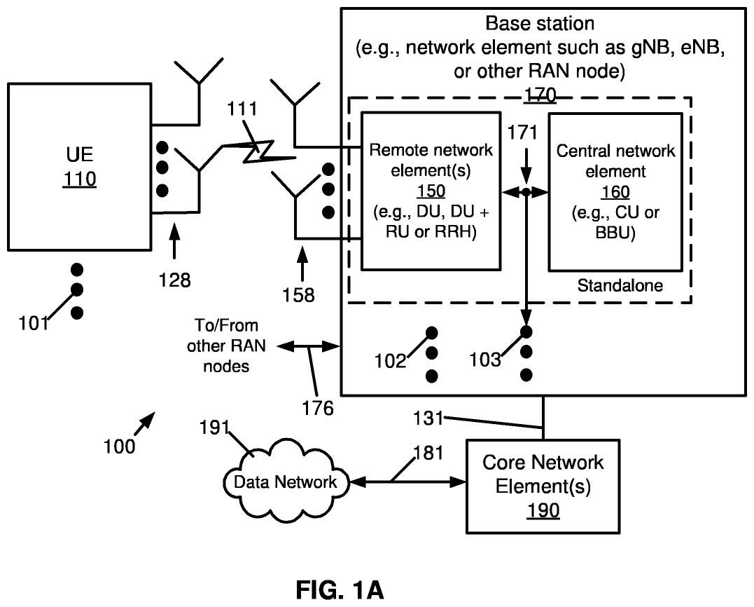

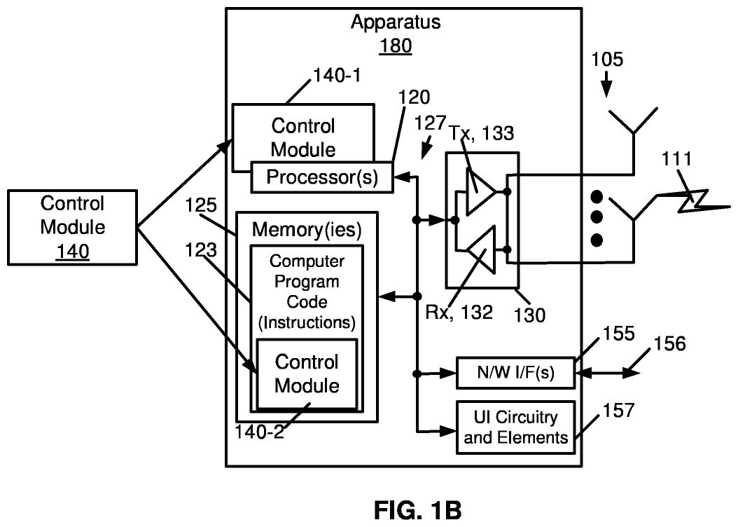

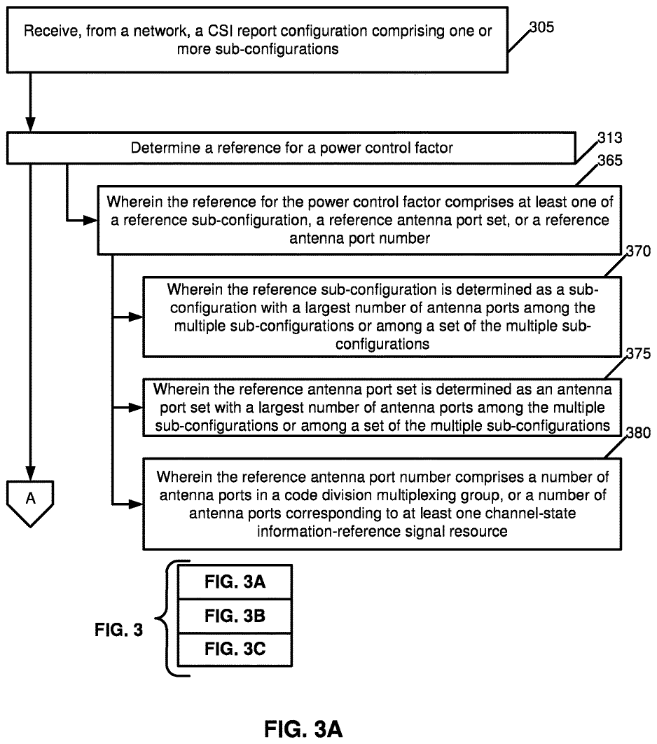

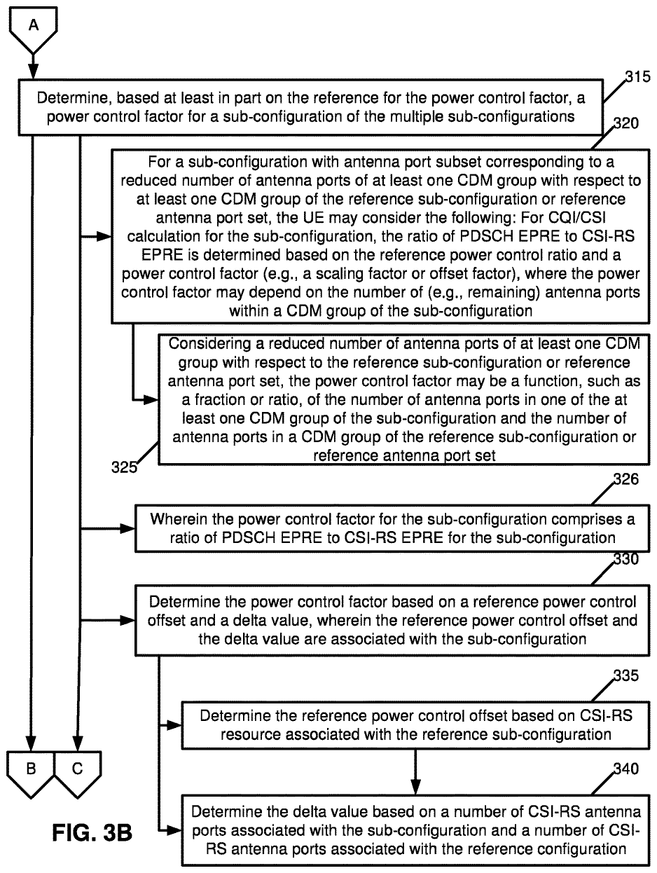

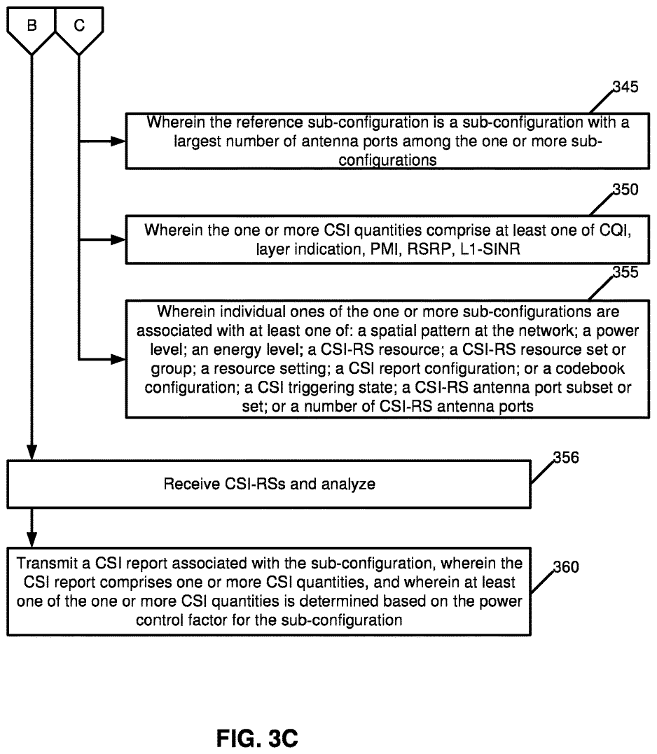

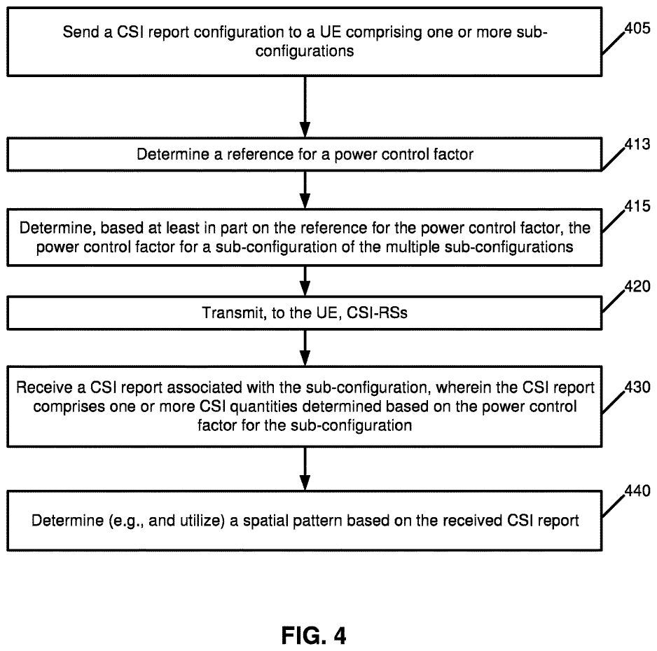

Any flow diagram (e.g., see FIGS. 3 and 4) or signaling diagram herein is considered to be a logic flow diagram, and illustrates the operation of an exemplary method, results of execution of computer program instructions embodied on a computer readable memory, functions performed by logic implemented in hardware, and/or interconnected means for performing functions in accordance with an exemplary embodiment. Block diagrams (such as FIGS. 1A and 1B) also illustrate the operation of an exemplary method, results of execution of computer program instructions embodied on a computer readable memory, functions performed by logic implemented in hardware, and/or interconnected means for performing functions in accordance with an exemplary embodiment.

The exemplary embodiments herein describe techniques for facilitating CSI derivation considering spatial adaptation. Additional description of these techniques is presented after a system into which the exemplary embodiments may be used is described.

Turning to FIG. 1A, this figure shows a block diagram of one possible and non-limiting exemplary system in which the exemplary embodiments may be practiced. A number of nodes are shown: a user equipment (UE) 110; a base station 170; and core network element(s) 190.

In FIG. 1A, a user equipment (UE) 110, as one of the nodes and as a network element, is in wireless communication via wireless link 111 with a wireless network 100. A UE 110 is a wireless, typically mobile device that can access a wireless network. The UE 110 is illustrated with one or more antennas 128. The ellipses 101 indicate there could be multiple UEs 110.

The base station 170, as another of the nodes but one that is a network element that is part of the wireless network 100, provides access by wireless devices such as the UE 110 to the wireless network 100. The base station 170 is illustrated as having one or more antennas 158. There are many options for the base station 170. In general, the base station 170 is a RAN node, and in particular could be a gNB, which is the primary term used herein. That is, the base station 170 will be referred to as gNB 170. There are, however, many options including an eNB for the base station, or options other than cellular systems.

There are a number of configurations for the base station 170. One such is a “standalone” configuration, which includes all circuitry as part of a single unit, and accesses the antennas 158. More commonly today, circuitry is split into one or more remote network elements 150 (accessing antennas 158) and central network elements 160. For instance, for 5G (also referred to as NR), a gNB might include a distributed unit (DU), or DU and radio unit (RU) as the remote network elements(s), and a central unit (CU) as the central network element 160. For LTE, the base station 170 might include an eNB having a remote radio head as remote network element 150 and a base band unit (BBU) as a central network element 160. The remote network element(s) 150 are coupled to a central network element 160 via one or more links 171. There could be multiple remote network elements 150 for a single central network element 160, and this is indicated by ellipses 102, indicating multiple remote network elements, and ellipses 103, indicating additional links 171. The remote network elements 150 are remote in the sense they are contained in different physical enclosures from a physical enclosure containing a corresponding central network element 160. The link(s) 171 may be implemented using fiber optics, wireless techniques, or any other technique for data communications.

Two or more base stations 170 communicate using, e.g., link(s) 176. The link(s) 176 may be wired or wireless or both and may implement, e.g., an Xn interface for 5G, an X2 interface for LTE, or other suitable interface for other standards.

The wireless network 100 may include a core network element or elements 190, as a third illustrated node, that may include core network functionality, and which provide connectivity via a link or links 181 with a data network 191, such as a telephone network and/or a data communications network (e.g., the Internet). Such core network functionality for 5G may include access and mobility management function(s) (AMF(s)) and/or user plane functions (UPF(s)) and/or session management function(s) (SMF(s)). Such core network functionality for LTE may include MME (Mobility Management Entity) functionality and/or SGW (Serving Gateway) functionality. These are merely exemplary functions that may be supported by the core network element(s) 190, and note that both 5G and LTE functions might be supported. The base station 170 is coupled via a link 131 to a core network element 190. The link 131 may be implemented as, e.g., an NG interface for 5G, or an S1 interface for LTE, or other suitable interface for other standards.

It is noted that description herein indicates that “cells” perform functions, but it should be clear that the base station that forms the cell will perform the functions. The cell makes up part of a base station. That is, there can be multiple cells per base station. For instance, there could be three cells for a single carrier frequency and associated bandwidth, each cell covering one-third of a 360-degree area so that the single base station's coverage area covers an approximate oval or circle. Furthermore, each cell can correspond to a single carrier and a base station may use multiple carriers. So, if there are three 120-degree cells per carrier and two carriers, then the base station has a total of six cells.

In general, the various embodiments of the user equipment 110 can include, but are not limited to, cellular telephones (such as smart phones, mobile phones, cellular phones, voice over Internet Protocol (IP) (VoIP) phones, and/or wireless local loop phones), tablets, portable computers, vehicles or vehicle-mounted devices for, e.g., wireless V2X (vehicle-to-everything) communication, image capture devices such as digital cameras, gaming devices, music storage and playback appliances, Internet appliances (including Internet of Things, IoT, devices), IoT devices with sensors and/or actuators for, e.g., automation applications, as well as portable units or terminals that incorporate combinations of such functions, laptop-embedded equipment (LEE), laptop-mounted equipment (LME), Universal Serial Bus (USB) dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. That is, the UE 110 could be any end device that may be capable of wireless communication. By way of example rather than limitation, the UE may also be referred to as a communication device, terminal device (MT), a Subscriber Station (SS), a Portable Subscriber Station, a Mobile Station (MS), or an Access Terminal (AT).

Turning to FIG. 1B, this figure is an example of a block diagram of an apparatus 180 suitable for implementing any of the nodes in FIG. 1A. The apparatus 180 includes circuitry comprising one or more processors 120, one or more memories 125, one or more transceivers 130, one or more network (N/W) interface(s) (I/F(s)) 155 and user interface (UI) circuitry and elements 157, interconnected through one or more buses 127. Since this is an example covering all of the nodes in FIG. 1A, some of the nodes may not have all of the circuitry. For example, a base station 170 might not have UI circuitry and elements 157. All of the nodes may have additional circuitry, not described here. FIG. 1B is presented merely as an example.

Each of the one or more transceivers 130 includes a receiver, Rx, 132 and a transmitter, Tx, 133. The one or more buses 127 may be address, data, and/or control buses, and may include any interconnection mechanism, such as a series of lines on a motherboard or integrated circuit, fiber optics or other optical communication equipment, and the like. The one or more transceivers 130 are connected to one or more antennas 105, which could be one of the antennas 128 (from UE 110) or antennas 158 (from base station 170), and may communicate using wireless link 111.

The one or more memories 125 include computer program code 123. The apparatus 180 includes a control module 140, comprising one of or both parts 140-1 and/or 140-2, which may be implemented in a number of ways. The control module 140 may be implemented in hardware as control module 140-1, such as being implemented as part of the one or more processors 120. The control module 140-1 may be implemented also as an integrated circuit or through other hardware such as a programmable gate array. In another example, the control module 140 may be implemented as control module 140-2, which is implemented as computer program code (having corresponding instructions) 123 and is executed by the one or more processors 120. For instance, the one or more memories 125 store instructions that, when executed by the one or more processors 120, cause the apparatus 180 to perform one or more of the operations as described herein. Furthermore, the one or more processors 120, one or more memories 125, and example algorithms (e.g., as flowcharts and/or signaling diagrams), encoded as instructions, programs, or code, are means for causing performance of the operations described herein.

The network interface(s) (N/W I/F(s)) 155 are wired interfaces communicating using link(s) 156, which could be fiber optic or other wired interfaces. The link(s) 156 could be the link(s) 131 and/or 176 from FIG. 1A. The link(s) 131 and/or 176 from FIG. 1A could also be implements using transceiver(s) 130 and corresponding wireless link(s) 111. The apparatus could include only wireless transceiver(s) 130, only N/W I/Fs 155, or both wireless transceiver(s) 130 and N/W I/Fs 155.

The apparatus 180 may or may not include UI circuitry and elements 157. These could include a display such as a touchscreen, speakers, or interface elements such as for headsets. For instance, a UE 110 of a smartphone would typically include at least a touchscreen and speakers. The UI circuitry and elements 157 may also include circuitry to communicate with external UI elements (not shown) such as displays, keyboards, mice, headsets, and the like.

The computer readable memories 125 may be of any type suitable to the local technical environment and may be implemented using any suitable data storage technology, such as semiconductor-based memory devices, flash memory, firmware, magnetic memory devices and systems, optical memory devices and systems, fixed memory and removable memory. The computer readable memories 125 may be means for performing storage functions. The processors 120 may be of any type suitable to the local technical environment, and may include one or more of general-purpose computers, special purpose computers, microprocessors, digital signal processors (DSPs) and processors based on a multi-core processor architecture, as non-limiting examples. The processors 120 may be means for performing functions, such as controlling the apparatus 180, and other functions as described herein.

Having thus introduced one suitable but non-limiting technical context for the practice of the exemplary embodiments, the exemplary embodiments will now be described with greater specificity. Before proceeding with examples of embodiments, however, an overview of the technical areas into which the embodiments could be implemented is provided.

Network energy saving is of great importance for environmental sustainability, to reduce environmental impact (e.g., greenhouse gas emissions), and for operational cost savings. As 5G is becoming pervasive across industries and geographical areas, handling more advanced services and applications requiring very high data rates (e.g., XR), networks are becoming denser, use more antennas, larger bandwidths and more frequency bands. The environmental impact of 5G needs to stay under control, and novel solutions to improve network energy savings need to be developed.

Energy consumption has become a key part of the operators' OPEX. According to a report from GSMA (Global System for Mobile Association), the energy cost on mobile networks accounts for ~23% of the total operator cost. Most of the energy consumption comes from the radio access network and in particular from the Active Antenna Unit (AAU), with data centers and fiber transport accounting for a smaller share. The power consumption of a radio access can be split into two parts: the dynamic part, which is only consumed when data transmission/reception is ongoing, and the static part, which is consumed all the time to maintain the necessary operation of the radio access devices, even when the data transmission/reception is not on-going.

This power consumption also can include signaling, such as using CSI. Some background on CSI is now presented.

CSI-RSs are UE-specifically configured reference signals in RRC. However, CSI-RSs can be shared among many UEs, i.e., more than one UE are configured to receive the same resource elements (REs).

In general, in order to save on DL resources, the gNB would try to use cell-specific or group-specific CSI-RS resources. The worst case of DL overhead is with UE-specific CSI-RS, where the DL overhead increases linearly with the number of UEs in the cell.

CSI-RS has many functions in NR, including the following:
1) CSI-RS for DL CSI acquisition;
2) CSI-RS for beam management (BM) (based on L1-RSRP);
3) CSI-RS for tracking (TRS);
4) UL CSI acquisition in reciprocity-based UL precoding.

In some applications (e.g., CSI-RS for BM) CSI-RS are spatially beamformed into different directions.

In general, a UE can be configured with up to 48 report configurations per component carrier (CC)/4 per bandwidth part (BWP). One CSI resource configuration within one report configuration can be configured with up to 16 resource sets (aperiodic CSI) and one resource set (otherwise). In each CSI resource set, up to 64 NZP CSI-RS resources and 1 NZP-CSI-RS resource up to 32 antenna ports can be configured.

For CSI acquisition, the UE is configured also with a codebook type. Given the measured channel across a CSI-RS resource, the UE can choose a favorite codeword from the specified codebook, i.e., precoding matrix indicator (PMI), along with channel quality indicator (CQI), rank indicator (RI). UE can also be configured to measure several CSI-RS resources (up to 8) within a resource set and report the favorite resource, CSI-RS resource indicator (CRI), along with PMI, CQI and RI which corresponds to that selected resource.

The next topic to discuss is the time domain. In the time domain, a CSI-RS resource may start at any OFDM symbol of a slot and the resource spans 1, 2, or 4 OFDM symbols depending on the number of ports configured.

Likewise, the UE measurement reporting of CSI can be also operated with periodic, semi-persistent, or aperiodic manner, which is so-called report types in a NR report configuration. However, there are certain limitations, based on which the UE periodic report can operate only based on the configured periodic CSI-RS resource-set, the UE semi-persistent report can operate based on both configured periodic and semi-persistent CSI-RS resource-set, and the UE aperiodic report can operate based on all periodic, semi-persistent, and aperiodic CSI-RS resource-set. These issues may be succinctly described as follows:
1) the periodic CSI-RS resources can be used to generate any report type;
2) the semi-persistent and periodic CSI-RS resources can be used to generate semi-persistent CSI reports; and
3) the aperiodic CSI-RS can only be utilized to generate the aperiodic report.

All CSI-RS resources within one set are configured with same density and same nrofPorts (number of ports), except for the NZP CSI-RS resources used for interference measurement.

For semi-persistent and aperiodic CSI-RS, the actual triggering of CSI-RS transmission is per CSI-RS resource set via either MAC CE or DCI. And a resource set can be used as part of UE report configurations describing what to be measured and, correspondingly, which measurement reporting are to be performed by the UE. Specifically, if a CSI-RS resource-set is configured as ‘aperiodic’ by RRC, the CSI-RS resource set configuration includes a slot offset, aperiodicTriggeringOffset, which defines the time interval between the triggering DCI and the CSI-RS transmission.

For A-CSI reporting, up to 16 different reporting settings can be triggered with a single DCI (e.g., for multiple component carriers) while SP-CSI reporting can trigger only one report setting with a single DCI. In order to trigger several SP-CSI reports (each in different slots), multiple DCIs are needed.

Another aspect is CDM Groups. A CDM group includes a number of consecutively numbered antenna ports mapped to a number of contiguous REs (resource elements) in frequency and/or time. All ports within a CDM group are mapped to all REs within the CDM group. Each port within a CDM group is further associated with a different orthogonal cover code (OCC), allowing the physical channel associated with each antenna port to be distinguished.

Consider now power control offset (Pc ratio). In the current specifications, the P_{c} ratio, also known as power control offset (PowerControlOffset) is the ratio between the PDSCH EPRE (energy per resource element) of all PDSCH ports and the CSI-RS EPRE of all CSI-RS ports multiplexed on one subcarrier. This ratio is configured per NZP CSI-RS resource. This ratio is used when the UE derives CSI feedback.

Enhancements on CSI and beam management related procedures is under study in Rel-18 NR. These potential enhancements include measurement and report, and signaling to enable efficient adaptation of spatial elements (e.g., antenna ports, active transceiver chains). Another example is enhancements on CSI related procedures including measurement and report, and signaling to enable efficient adaptation of power offset values between PDSCH and CSI-RS. See, e.g., RP-223540, Huawei, “New WID: Network energy savings for NR”, 3GPP TSG RAN Meeting #98-e, Electronic Meeting, Dec. 12-16, 2022.

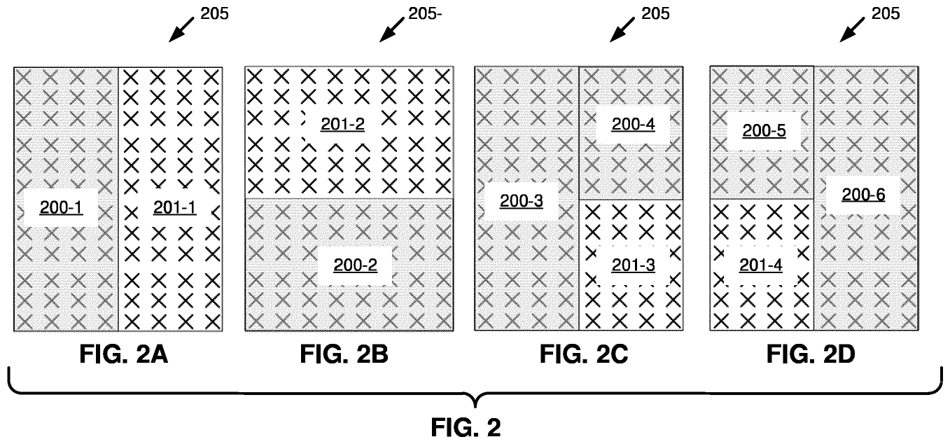

Based on adaptation of spatial elements, FIG. 2 illustrates an example illustrating some spatial (adaptation) patterns, where dotted/grey boxes correspond to muted spatial elements. FIG. 2 is split into FIGS. 2A, 2B, 2C, and 2D. Each of these figures has a vertical and horizontal space 205 suitable for patterns of spatial elements, where sections 200 contain muted spatial elements and the remaining sections 201 have non-muted spatial elements. The spaces 205 are the same, but the allocation to muted and non-muted elements is different for each figure. FIG. 2A shows a version where the space is split vertically between muted spatial elements 200-1 and non-muted spatial elements 201-1; FIG. 2B shows a version where the space is split horizontally between non-muted spatial elements 201-2 on top and muted spatial elements 200-2 on bottom; FIG. 2C shows a version where the space is split vertically between muted spatial elements 200-3 on the left side and the right side is split horizontally between muted spatial elements 200-4 and non-muted spatial elements 201-3; and FIG. 2D shows a version where the space is split vertically between muted spatial elements 200-6 on the right side and the left side is split horizontally between muted spatial elements 200-5 and non-muted spatial elements 201-4. These are examples of non-limiting types of spatial parameters that can be used.

Some of the recent RAN1 agreements on the first specified objective after “Specify the following techniques in spatial and power domains” are copied below:

Agreement
At least support A2-2, i.e., one CSI report configuration contains multiple CSI report sub-
configurations where each sub-configuration corresponds to one spatial adaptation pattern.

| | |
|---|---|
| - | FFS: impact on CSI processing requirement |

Agreement
For a CSI report config with L sub-configuration(s), support a framework that enables a UE to
report N CSI(s) in one reporting instance where the N CSI(s) are associated with N sub-
configuration(s) from L and each CSI corresponds to one sub-configuration.

| | |
|---|---|
| - | For discussion purpose, N=1 refers to single-CSI while N>1 refers to multi-CSI. |
| - | For Semi-persistent/Aperiodic CSI reporting, support gNB trigger/indicate/activate |

report of N≤L CSIs where N>=1

| | |
|---|---|
| - | The maximum value of N and L are subject to UE capability |
| - | Further study how to address/minimize additional UE complexity |

The following bullet not agreed due to objection from Apple and vivo

| | |
|---|---|
| - | For Periodic CSI reporting, at least the case of N=L is supported where N>=1 |

Agreement
For CSI report configuration, if L>1 in a CSI report configuration, at least the following can be
included for each sub-configuration for Type 1 SD adaptation

| ▪ | N1, N2 for single-panel and N1, N2, Ng for multi-panel |
|---|---|
| | ∘ FFS: details on explicit indication or implicit derivation |
| ▪ | Port subset indication when A1-2 is used (if A1-2 is supported) |
| | ∘ FFS: details on explicit indication or implicit derivation |
| ▪ | FFS: rank restriction |
| ▪ | FFS: codebook subset restriction |
| ▪ | FFS: supported codebook types for PMI, e.g., Type-I or Type-II |
| ▪ | FFS: report quantity |
| ▪ | FFS: reportFreqConfiguration |
| ▪ | FFS: Group identity of NZP CSI-RS resource(s) in a resource set for channel |

measurement when A1-1 is used

For CSI report configuration for type 2 SD adaptation, further study under which cases sub-
configurations may or may not be needed including sub-configuration content

As noted, (dynamic) spatial adaptation will be specified in Rel-18 NR. Looking at the above agreements, it can be seen that CSI enhancements will be specified, wherein a UE may calculate and/or report multiple CSIs corresponding to different spatial (e.g., adaptation) patterns. This is to enable the gNB to make appropriate decision regarding spatial adaptation.

In this document, focus is placed in part on the aspect of CSI calculation/derivation in order to enable efficient spatial adaptation procedures. Specifically, the focus is at least partly on the ratio between PDSCH EPRE and CSI-RS EPRE, for CSI (such as CQI) calculation operation considering different spatial adaptation patterns.

In terms of the network energy expenditure described above, dynamic spatial adaptation (i.e., the gNB switching from one spatial pattern to another) allows achieving network energy savings, as a spatial pattern could have fewer spatial elements that are active (so less energy consumption). Embodiments herein consider the CSI the UE would provide to the gNB to assist the gNB in making the decision of a suitable spatial pattern to use. Specifically, on the CSI calculation by the UE, it is proposed to enhance the determination of CSI quantities based on certain examples herein.

The following part is described with reference to FIG. 3, which is split over FIGS. 3A and 3B and which is a flowchart performed by a UE of facilitating CSI derivation considering spatial adaptation in accordance with an example. The main operations are as follows. In block 305, the UE 110 receives, from a network, a CSI report configuration comprising one or more sub-configurations. The UE 110 in block 313 determines a reference for a power control factor. The UE determines, in block 315 and based at least in part on the reference for the power control factor, a power control factor for a sub-configuration of the multiple sub-configurations. The UE 110 receive CSI-RSs and analyzes these in block 356. In block 360, the UE transmits, to the network, a channel state information report associated with the sub-configuration, wherein the CSI report comprises one or more CSI quantities, and wherein at least one of the one or more CSI quantities is determined based on the power control factor for the sub-configuration.

Concerning the CSI report configuration of block 305, consider the following, which are addressed below. Consider a UE configured with a CSI report configuration that includes or is associated with multiple sub-configurations, where individual ones of the multiple sub-configurations correspond to or indicate at least one CSI-RS antenna port subset/set (or number), and
1) considering the sub-configuration with the largest number of antenna ports as a reference sub-configuration, and the corresponding antenna port subset/set as a reference antenna port set, or more generally considering a reference antenna port set for the CSI report configuration, and
2) considering a power control ratio (Pc ratio), e.g., corresponding to the reference sub-configuration or to the associated CSI-RS resource.

It is noted that a set of antenna ports may refer to all antenna ports of a CSI-RS resource (although not all ports in general), or to a maximum of antenna port number of different sets/subsets of antenna ports of different sub-configurations. This set could also correspond to a sub-configuration. Then there may be other sub-configurations that correspond to or indicate antenna port subsets of this set, where a subset contains less than a set.

As one example of block 313, in block 365, the reference for power control factor comprises at least one of a reference sub-configuration, a reference antenna port set, or a reference antenna port number. Blocks 370, 375, and 380 are possible examples of block 365. In block 370, the reference sub-configuration is determined as a sub-configuration with a largest number of antenna ports among the multiple sub-configurations or among a set of the multiple sub-configurations. In block 375, the reference antenna port set is determined as an antenna port set with a largest number of antenna ports among the multiple sub-configurations or among a set of the multiple sub-configurations. In block 380, the reference antenna port number comprises a number of antenna ports in a code division multiplexing group, or a number of antenna ports corresponding to at least one channel-state information-reference signal resource.

As one example of block 315, consider block 320. In block 320, for a sub-configuration with antenna port subset corresponding to a reduced number of antenna ports of at least one CDM (code division multiplexing) group with respect to at least one CDM group of the reference sub-configuration or reference antenna port set, the UE may consider the following: For CQI/CSI calculation for the sub-configuration, the ratio of PDSCH EPRE to CSI-RS EPRE is determined based on the reference power control ratio and a power control factor (e.g., scaling factor or offset factor). The power control factor (e.g., scaling factor or offset factor) may depend on the number of (e.g., remaining) antenna ports within a CDM group of the sub-configuration. It is noted that the scaling factor and offset factor are to be used for different scales (linear scale or dB scale, respectively, as shown examples below).

Specifically, see block 325, considering a reduced number of antenna ports of at least one CDM group with respect to the reference sub-configuration or reference antenna port set, the power control factor (e.g., scaling factor or offset factor) may be a function, such as a fraction or ratio, of the number of antenna ports in one of the at least one CDM group of the sub-configuration and the number of antenna ports in a CDM group of the reference sub-configuration or reference antenna port set.

If the sub-configuration has frequency-domain multiplexed CDM groups that have different number of antenna ports, the scaling/offset factor may be a function, such as fraction or ratio, of the minimum/maximum number of antenna ports among the at least one CDM group of the sub-configuration and the number of antenna ports in a CDM group of the reference sub-configuration or reference antenna port set.

For example, assuming two ports in a CDM group of a sub-configuration and four ports in a CDM group of the reference sub-configuration or reference antenna port set:
1) in linear scale, the ratio of PDSCH EPRE to CSI-RS EPRE to be assumed for the CSI/CQI calculation for the sub-configuration would be: P_{c}2/4=P_{c}/2. In this case, the scaling factor is 1/2.
2) in dB scale, the ratio of PDSCH EPRE to CSI-RS EPRE to be assumed for the CSI/CQI calculation for the sub-configuration would be: P_{c}+10 log₁₀(2/4)=P_{c}−3 dB. In this case, the offset factor is −3 dB.
3) Note: the above example could be generalized by replacing 2 by X and 4 by Y, where X and Y can take any value, e.g., from 2 to 8.

The UE may assume that the PDSCH signals transmitted on the subset of antenna ports of the sub-configuration would have an EPRE to CSI-RS EPRE ratio determined as above.

The above proposed operation for the determination of ratio of PDSCH EPRE to CSI-RS EPRE may be defined/applied per OFDM symbol or per set of OFDM symbols. The CSI-RS antenna port subsets corresponding respectively to multiple sub-configurations may be associated with a same CSI-RS resource (or even resource set).

Additionally, or alternatively, the CSI-RS antenna ports of a sub-configuration may be a subset of a set (or a number of) CSI-RS antenna ports indicated through the CSI report configuration that includes the sub-configuration. Alternatively, the CSI-RS antenna ports of one sub-configuration may be a subset of a set of CSI-RS antenna ports of another/reference CSI report sub-configuration, where the two sub-configurations are included or correspond to a same CSI-RS report configuration.

In block 326, the power control factor for the sub-configuration comprises a ratio of PDSCH EPRE to CSI-RS EPRE for the sub-configuration. In block 330, the power control factor may be determined based on a reference power control offset and a delta value, wherein the reference power control offset and the delta value are associated with the sub-configuration. In block 335, the reference power control offset may be determined based on CSI-RS resource associated with the reference sub-configuration. In block 340, the delta value may be determined (from block 330 or 335) based on a number of CSI-RS antenna ports associated with the sub-configuration and a number of CSI-RS antenna ports associated with the reference configuration.

In block 345, the reference sub-configuration is a sub-configuration with a largest number of antenna ports among the one or more sub-configurations. The one or more CSI quantities may (see block 350) comprise at least one of CQI, layer indication, PMI, RSRP, L1-SINR.

Individual ones of the multiple sub-configurations in the CSI report configuration may correspond to or be associated to at least one of the following (see block 355):
1) spatial (adaptation) pattern—different patterns have different sub-set/set (or number) of active/muted spatial elements, (such as antenna ports, antenna elements, or the like);
2) power level;
3) energy level;
4) CSI-RS resource;
5) CSI-RS resource set or group;
6) Resource setting;
7) CSI report configuration;
8) Codebook configuration;
9) A CSI triggering state;
10) A CSI-RS antenna port subset or set; or
11) A number of CSI-RS antenna ports.

The UE may be triggered/activated/indicated via MAC CE/DCI to compute CSI/CQI for one or more sub-configurations of a CSI report configuration.

The following is an example of how the embodiments may be implemented.

In an example, the UE can assume that the corresponding PDSCH signals for vⱼ layers transmitted on the P antenna ports of a CSI-RS resource in a Group j would have a ratio of EPRE to CSI-RS EPRE equal to the powerControlOffset of the respective CSI-RS resource, for j=1,2.

As a specific example, if a UE is configured with a CSI report configuration that includes or is associated with multiple sub-configurations, where each of the multiple sub-configurations corresponds to or indicates a CSI-RS antenna port subset, for CQI calculation for a sub-configuration indicating or associated to an antenna port subset [p⁽⁰⁾, . . . , p^{(P-1)}] of size P, then: The UE should assume that the corresponding PDSCH signals transmitted on the antenna port subset [p⁽⁰⁾, . . . , p^{(P-1)}] would have a ratio of EPRE to CSI-RS EPRE equal to powerControlOffset+delta, where powerControlOffset is of the CSI-RS resource of the sub-configuration and delta=10 log₁₀ (N/N_{ref}), where N is a number of antenna ports within a CDM group of the sub-configuration and N_{ref} is a number of antenna ports within a CDM group of the sub-configuration with the largest number of antenna ports (among the multiple sub-configurations). If there is no CDM group(s) for the sub-configuration or if N=N_{ref}, delta=0.

It's worth noting that, although the focus has been on CQI herein, other CSI parameters might also be considered such as LI (layer indication), RSRP, L1-SINR, or the like This could be performed by essentially replacing CQI by any of these CSI parameters.

Turning to FIG. 4, this figure is a flowchart performed by a network element of facilitating CSI derivation considering spatial adaptation in accordance with an example. This may be assumed to be performed by a gNB 170, as one example of a network element able to perform these operations.

In block 405, the network element sends a CSI report configuration to a UE comprising one or more sub-configurations. The network element in block 413 determines a reference for a power control factor, and determine, in block 415 and based at least in part on the reference for the power control factor, the power control factor for a sub-configuration of the multiple sub-configurations. The network element transmits (or causes transmission of), to the UE, CSI-RSs, see block 420. In block 430, the network element receives a CSI report associated with the sub-configuration, wherein the CSI report comprises one or more CSI quantities determined based on the power control factor for the sub-configuration. In block 440, the network element determines (e.g., and utilizes) a spatial pattern based on the received CSI report. The network element determines the spatial pattern at least partially based on assistance information reported from the UE. In an example embodiment, the assistance information comprises the CSI report. As for utilization, the network element may decide to apply the determined spatial pattern. In an example embodiment, the spatial pattern could be used for transmissions of all downlink signals/channels. In another example embodiment, the spatial pattern could be used for transmissions of some downlink signals/channels, for example, PDSCH only. In a further example, the determined spatial pattern can be used by the network element to utilize which antenna ports/antenna elements, and/or at what level of energy setting these are used.

Without in any way limiting the scope, interpretation, or application of the claims appearing below, a technical effect and/or advantage of one or more of the example embodiments disclosed herein is enabling correct CQI calculation for a sub-configuration/spatial adaptation pattern corresponding to an antenna port subset/set. Another technical effect and/or advantage of one or more of the example embodiments disclosed herein is adapting CSI calculation considering multiple sub-configuration/spatial adaptation patterns.

The following are additional examples.

Example 1. A method, comprising: receiving, at a user equipment from a network, a channel state information report configuration comprising multiple sub-configurations; determining, by the user equipment, a reference for a power control factor; determining, by the user equipment, based at least in part on the reference for the power control factor, the power control factor for a sub-configuration of the multiple sub-configurations; and transmitting, by the user equipment to the network, a channel state information report associated with the sub-configuration, wherein the channel state information report comprises one or more channel state information quantities, and at least one of the one or more channel state information quantities is determined based on the power control factor for the sub-configuration.

Example 2. The method according to example 1, wherein the reference for the power control factor comprises at least one of a reference sub-configuration, a reference antenna port set, or a reference antenna port number.

Example 3. The method according to example 2, wherein the reference sub-configuration is determined as a sub-configuration with a largest number of antenna ports among the multiple sub-configurations or among a set of the multiple sub-configurations.

Example 4. The method according to example 2, wherein the reference antenna port set is determined as an antenna port set with a largest number of antenna ports among the multiple sub-configurations or among a set of the multiple sub-configurations.

Example 5. The method according to example 2, wherein the reference antenna port number comprises a number of antenna ports in a code division multiplexing group, or a number of antenna ports corresponding to at least one channel-state information-reference signal resource.

Example 6. The method according to example 1, wherein the power control factor for the sub-configuration comprises a ratio of physical downlink shared channel energy per resource element to channel state information-reference signal energy per resource element for the sub-configuration.

Example 7. The method according to example 1, wherein the power control factor for the sub-configuration is determined based on a reference power control offset and a delta value.

Example 8. The method according to example 7, wherein the reference power control offset is determined based on channel state information-reference signal resource associated with the reference for the power control factor.

Example 9. The method according to example 7 or 8, wherein the delta value is determined based on a number of channel state information-reference signal antenna ports associated with the sub-configuration and a number of channel state information-reference signal antenna ports associated with the reference for the power control factor.

Example 10. The method according to example 11, wherein the delta value is determined based on a ratio of the number of channel state information-reference signal antenna ports associated with the sub-configuration and the number of channel state information-reference signal antenna ports associated with the reference for the power control factor.

Example 11. The method according to example 11, wherein the delta value is determined based on a ratio of the number of channel state information-reference signal antenna ports in a code division multiplexing group associated with the sub-configuration and the number of channel state information-reference signal antenna ports in a code division multiplexing group associated with the reference for the power control factor.

Example 12. The method according to any one of examples 1 to 11, wherein the one or more channel state information quantities comprise at least one of channel quality indicator, layer indication, precoding matrix indicator, reference signal received power, or layer 1-signal to interference plus noise ratio.

Example 13. The method according to any one of examples 1 to 12, wherein the sub-configuration of the multiple sub-configurations is associated with at least one of: a spatial pattern at the network; a power level; an energy level; a channel state information-reference signal resource; a channel state information-reference signal resource set or group; a resource setting; a channel state information report configuration; a codebook configuration; a channel state information triggering state; a channel state information-reference signal antenna port subset or set; or a number of channel state information-reference signal antenna ports.

Example 14. A method, comprising: sending, by a network element to a user equipment, a channel state information report configuration comprising multiple sub-configurations; receiving a channel state information report associated with a sub-configuration of the multiple sub-configurations, wherein the channel state information report comprises one or more channel state information quantities determined based on a power control factor for the sub-configuration; and determining a spatial pattern based on the received channel state information report.

Example 15. The method according to example 14, further comprising, prior to the receiving the channel state information report, transmitting by the network element channel state information reference signals to the user equipment.

Example 16. The method according to example 14 or 15, further comprising: determining, by the network element, a reference for the power control factor; and determining, by the network element based at least in part on the reference for the power control factor, the power control factor for the sub-configuration.

Example 17. A computer program, comprising instructions for performing the methods of any of examples 1 to 16, when the computer program is run on an apparatus.

Example 18. The computer program according to example 17, wherein the computer program is a computer program product comprising a computer-readable medium bearing instructions embodied therein for use with the apparatus.

Example 19. The computer program according to example 17, wherein the computer program is directly loadable into an internal memory of the apparatus.

Example 20. An apparatus, comprising means for performing: receiving, at a user equipment from a network, a channel state information report configuration comprising multiple sub-configurations; determining, by the user equipment, a reference for a power control factor; determining, by the user equipment, based at least in part on the reference for the power control factor, the power control factor for a sub-configuration of the multiple sub-configurations; and transmitting, by the user equipment to the network, a channel state information report associated with the sub-configuration, wherein the channel state information report comprises one or more channel state information quantities, and at least one of the one or more channel state information quantities is determined based on the power control factor for the sub-configuration.

Example 21. The apparatus according to example 20, wherein the reference for the power control factor comprises at least one of a reference sub-configuration, a reference antenna port set, or a reference antenna port number.

Example 22. The apparatus according to example 21, wherein the reference sub-configuration is determined as a sub-configuration with a largest number of antenna ports among the multiple sub-configurations or among a set of the multiple sub-configurations.

Example 23. The apparatus according to example 21, wherein the reference antenna port set is determined as an antenna port set with a largest number of antenna ports among the multiple sub-configurations or among a set of the multiple sub-configurations.

Example 24. The apparatus according to example 21, wherein the reference antenna port number comprises a number of antenna ports in a code division multiplexing group, or a number of antenna ports corresponding to at least one channel-state information-reference signal resource.

Example 25. The apparatus according to example 20, wherein the power control factor for the sub-configuration comprises a ratio of physical downlink shared channel energy per resource element to channel state information-reference signal energy per resource element for the sub-configuration.

Example 26. The apparatus according to example 20, wherein the power control factor for the sub-configuration is determined based on a reference power control offset and a delta value.

Example 27. The apparatus according to example 26, wherein the reference power control offset is determined based on channel state information-reference signal resource associated with the reference for the power control factor.

Example 28. The apparatus according to example 26 or 27, wherein the delta value is determined based on a number of channel state information-reference signal antenna ports associated with the sub-configuration and a number of channel state information-reference signal antenna ports associated with the reference for the power control factor.

Example 29. The apparatus according to example 28, wherein the delta value is determined based on a ratio of the number of channel state information-reference signal antenna ports associated with the sub-configuration and the number of channel state information-reference signal antenna ports associated with the reference for the power control factor.

Example 30. The apparatus according to example 28, wherein the delta value is determined based on a ratio of the number of channel state information-reference signal antenna ports in a code division multiplexing group associated with the sub-configuration and the number of channel state information-reference signal antenna ports in a code division multiplexing group associated with the reference for the power control factor.

Example 31. The apparatus according to any one of examples 20 to 30, wherein the one or more channel state information quantities comprise at least one of channel quality indicator, layer indication, precoding matrix indicator, reference signal received power, or layer 1-signal to interference plus noise ratio.

Example 32. The apparatus according to any one of examples 20 to 31, wherein the sub-configuration of the multiple sub-configurations is associated with at least one of: a spatial pattern at the network; a power level; an energy level; a channel state information-reference signal resource; a channel state information-reference signal resource set or group; a resource setting; a channel state information report configuration; a codebook configuration; a channel state information triggering state; a channel state information-reference signal antenna port subset or set; or a number of channel state information-reference signal antenna ports.

Example 33. An apparatus, comprising means for performing: sending, by a network element to a user equipment, a channel state information report configuration comprising multiple sub-configurations; receiving a channel state information report associated with a sub-configuration of the multiple sub-configurations, wherein the channel state information report comprises one or more channel state information quantities determined based on a power control factor for the sub-configuration; and determining a spatial pattern based on the received channel state information report.

Example 34. The apparatus according to example 33, wherein the means are further configured for performing: prior to the receiving the channel state information report, transmitting by the network element channel state information reference signals to the user equipment.

Example 35. The apparatus according to example 33 or 34, wherein the means are further configured for performing: determining, by the network element, a reference for the power control factor; and determining, by the network element based at least in part on the reference for the power control factor, the power control factor for the sub-configuration.

Example 36. The apparatus of any preceding apparatus example, wherein the means comprises: at least one processor; and at least one memory storing instructions that, when executed by at least one processor, cause the performance of the apparatus.

Example 37. An apparatus, comprising: one or more processors; and one or more memories storing instructions that, when executed by the one or more processors, cause the apparatus at least to perform: receiving, at a user equipment from a network, a channel state information report configuration comprising multiple sub-configurations; determining, by the user equipment, a reference for a power control factor; determining, by the user equipment, based at least in part on the reference for the power control factor, the power control factor for a sub-configuration of the multiple sub-configurations; and transmitting, by the user equipment to the network, a channel state information report associated with the sub-configuration, wherein the channel state information report comprises one or more channel state information quantities, and at least one of the one or more channel state information quantities is determined based on the power control factor for the sub-configuration.

Example 38. An apparatus, comprising: one or more processors; and one or more memories storing instructions that, when executed by the one or more processors, cause the apparatus at least to perform: sending, by a network element to a user equipment, a channel state information report configuration comprising multiple sub-configurations; receiving a channel state information report associated with a sub-configuration of the multiple sub-configurations, wherein the channel state information report comprises one or more channel state information quantities determined based on a power control factor for the sub-configuration; and determining a spatial pattern based on the received channel state information report.

As used in this application, the term “circuitry” may refer to one or more or all of the following:
(a) hardware-only circuit implementations (such as implementations in only analog and/or digital circuitry) and
(b) combinations of hardware circuits and software, such as (as applicable): (i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

Embodiments herein may be implemented in software (executed by one or more processors), hardware (e.g., an application specific integrated circuit), or a combination of software and hardware. In an example embodiment, the software (e.g., application logic, an instruction set) is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with one example of a computer described and depicted, e.g., in FIG. 1B. A computer-readable medium may comprise a computer-readable storage medium (e.g., memories 125 or other device) that may be any media or means that can contain, store, and/or transport the instructions for use by or in connection with an instruction execution system, apparatus, or device, such as a computer. A computer-readable storage medium does not comprise propagating signals, and therefore may be considered to be non-transitory. The term “non-transitory”, as used herein, is a limitation of the medium itself (i.e., tangible, not a signal) as opposed to a limitation on data storage persistency (e.g., RAM, random access memory, versus ROM, read-only memory).

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

The following abbreviations that may be found in the specification and/or the drawing figures are defined as follows:
5G fifth generation
A-CSI aperiodic CSI
AMF access and mobility management function
BBU base band unit
BM beam management
BWP bandwidth part
CC component carrier
CCE Control Channel Element
CDM code division multiplexing
CORESET Control Resource Set
CQI Channel Quality Indicator
CRI CSI-RS resource indicator
C-RNTI Cell Radio-Network Temporary Identifier
CSI Channel State Information
CSI-RS channel state information-reference signal
CU central unit
DCI Downlink Control Information
DL downlink (from network to UE)
DU distributed unit
eNB (or eNodeB) evolved Node B (e.g., an LTE base station)
EPRE energy per resource element
FR 1 Frequency Range 1
gNB (or gNodeB) base station for 5G/NR
HARQ Hybrid Automatic Repeat request
HARQ-ACK HARQ Acknowledgment
I/F interface
L1-SINR level 1-signal to interference plus noise ratio
LTE long term evolution
MAC CE Medium Access Control, Control Element
MME mobility management entity
ng or NG next generation
ng-eNB or NG-eNB next generation eNB
NR new radio
N/W or NW network
NZP non-zero power
OCC orthogonal cover code
OFDM orthogonal frequency division multiplexing
OPEX operating expenditure
PDCCH Physical Downlink Control Channel
PDSCH Physical Downlink Shared Channel
PMI precoding matrix indicator
PUCCH Physical Uplink Control Channel
PUSCH Physical Uplink Shared Channel
RAN radio access network
RE resource element
Rel release
RI rank indicator
RLC radio link control
RNTI Radio-Network Temporary Identifier
RRH remote radio head
RRC radio resource control
RS Reference Signal
RSRP reference signal received power
RU radio unit
Rx receiver
SGW serving gateway
SP-CSI semi-persistent CSI
SMF session management function
SR Scheduling Request
SRI SRS resource indicator
SRS Sounding Reference Signal
SSB Synchronization Signal Block
TCI Transmission Configuration Indicator
TDM Time Division Multiplexing
TRS tracking reference signal
TRP Transmission Reception Point
Tx transmitter
UCI Uplink Control Information
UE user equipment (e.g., a wireless, typically mobile device)
UI user interface
UL uplink (from UE to network)
UPF user plane function
WID working item description
XR extended reality

1-21. (canceled)

22. An apparatus comprising:
at least one processor; and
at least one memory storing instructions that, when executed by the at least one processor, cause the apparatus at least to perform:
receiving, from a network, a channel state information report configuration comprising multiple sub-configurations;
determining a reference for a power control factor;
determining based at least in part on the reference for the power control factor, the power control factor for a sub-configuration of the multiple sub-configurations; and
transmitting, to the network, a channel state information report associated with the sub-configuration, wherein the channel state information report comprises one or more channel state information quantities, and at least one of the one or more channel state information quantities is determined based on the power control factor for the sub-configuration.

23. The apparatus according to claim 22, wherein the reference for the power control factor comprises at least one of a reference sub-configuration, a reference antenna port set, or a reference antenna port number.

24. The apparatus according to claim 23, wherein the reference sub-configuration is determined as a sub-configuration with a largest number of antenna ports among the multiple sub-configurations or among a set of the multiple sub-configurations.

25. The apparatus according to claim 23, wherein the reference antenna port set is determined as an antenna port set with a largest number of antenna ports among the multiple sub-configurations or among a set of the multiple sub-configurations.

26. The apparatus according to claim 23, wherein the reference antenna port number comprises a number of antenna ports in a code division multiplexing group, or a number of antenna ports corresponding to at least one channel-state information-reference signal resource.

27. The apparatus according to claim 22, wherein the power control factor for the sub-configuration comprises a ratio of physical downlink shared channel energy per resource element to channel state information-reference signal energy per resource element for the sub-configuration.

28. The apparatus according to claim 22, wherein the power control factor for the sub-configuration is determined based on a reference power control offset and a delta value.

29. The apparatus according to claim 28, wherein the reference power control offset is determined based on channel state information-reference signal resource associated with the reference for the power control factor.

30. The apparatus according to claim 28, wherein the delta value is determined based on a number of channel state information-reference signal antenna ports associated with the sub-configuration and a number of channel state information-reference signal antenna ports associated with the reference for the power control factor.

31. The apparatus according to claim 30, wherein the delta value is determined based on a ratio of the number of channel state information-reference signal antenna ports associated with the sub-configuration and the number of channel state information-reference signal antenna ports associated with the reference for the power control factor.

32. The apparatus according to claim 30, wherein the delta value is determined based on a ratio of the number of channel state information-reference signal antenna ports in a code division multiplexing group associated with the sub-configuration and the number of channel state information-reference signal antenna ports in a code division multiplexing group associated with the reference for the power control factor.

33. The apparatus according to claim 22, wherein the one or more channel state information quantities comprise at least one of channel quality indicator, layer indication, precoding matrix indicator, reference signal received power, or layer 1-signal to interference plus noise ratio.

34. The apparatus according to claim 22, wherein the sub-configuration of the multiple sub-configurations is associated with at least one of:
a spatial pattern at the network;
a power level;
an energy level;
a channel state information-reference signal resource;
a channel state information-reference signal resource set or group;
a resource setting;
a channel state information report configuration;
a codebook configuration;
a channel state information triggering state;
a channel state information-reference signal antenna port subset or set; or
a number of channel state information-reference signal antenna ports.

35. An apparatus comprising:
at least one processor; and
at least one memory storing instructions that, when executed by the at least one processor, cause the apparatus at least to perform:
sending, to a user equipment, a channel state information report configuration comprising multiple sub-configurations;
receiving a channel state information report associated with a sub-configuration of the multiple sub-configurations, wherein the channel state information report comprises one or more channel state information quantities determined based on a power control factor for the sub-configuration; and
determining a spatial pattern based on the received channel state information report.

36. The apparatus according to claim 35, wherein the apparatus is further caused to perform:
prior to the receiving the channel state information report, transmitting channel state information reference signals to the user equipment.

37. The apparatus according to claim 35, wherein the apparatus is further caused to perform:
determining a reference for the power control factor; and
determining, based at least in part on the reference for the power control factor, the power control factor for the sub-configuration.

38. A method, comprising:
receiving, at a user equipment from a network, a channel state information report configuration comprising multiple sub-configurations;
determining, by the user equipment, a reference for a power control factor;
determining, by the user equipment, based at least in part on the reference for the power control factor, the power control factor for a sub-configuration of the multiple sub-configurations; and
transmitting, by the user equipment to the network, a channel state information report associated with the sub-configuration, wherein the channel state information report comprises one or more channel state information quantities, and at least one of the one or more channel state information quantities is determined based on the power control factor for the sub-configuration.

39. The method according to claim 38, wherein the power control factor for the sub-configuration comprises a ratio of physical downlink shared channel energy per resource element to channel state information-reference signal energy per resource element for the sub-configuration.

40. The method according to claim 38, wherein the one or more channel state information quantities comprise at least one of channel quality indicator, layer indication, precoding matrix indicator, reference signal received power, or layer 1-signal to interference plus noise ratio.

41. The method according to claim 38, wherein the sub-configuration of the multiple sub-configurations is associated with at least one of:
a spatial pattern at the network;
a power level;
an energy level;
a channel state information-reference signal resource;
a channel state information-reference signal resource set or group;
a resource setting;
a channel state information report configuration;
a codebook configuration;
a channel state information triggering state;
a channel state information-reference signal antenna port subset or set; or
a number of channel state information-reference signal antenna ports.
